(19) United States
(12) Patent Application Publication
(10) Pub. No.: US 2008/0072952 A1
(43) Pub. Date: Mar. 27, 2008

(54) Angle-adjustable solar energy device

(76) Inventor: Chen-Sung Liao, Taichung (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/524,600

(22) Filed: Sep. 21, 2006

(51) Int. Cl. H02N 6/00

(52) U.S. Cl. 136/246

(57) ABSTRACT

An angle-adjustable solar energy device includes: a fixed supporting frame having at least one cell that defines a cell space; a coupling frame received in the cell space, defining a frame space, and pivoted to the cell of the fixed supporting frame so as to be rotatable relative to the fixed supporting frame about a first axis; a solar cell carrier including a holder that is adapted to hold a solar cell, that extends into the frame space, and that is pivoted to the coupling frame so as to be rotatable relative to the coupling frame about a second axis which intersects the first axis; a universal joint connected to the holder; and a driving unit connected to the holder through the universal joint.

### BACKGROUND OF THE INVENTION

1. Field of the Invention

The invention relates to an angle-adjustable solar energy device, more particularly to an angle-adjustable solar energy device having a solar cell holder pivoted to a coupling frame which is pivoted to a fixed cell.

2. Description of the Related Art

As shown in FIG. 1, a conventional angle-adjustable solar energy device 100 includes a seat 10, a frame body 11 mounted on top of the seat 10 in such a manner that the angle of the frame body 11 is adjustable relative to the seat 10, and a plurality of solar energy plates 12 evenly mounted on the frame body 11. A motor (not shown) is mounted in the seat 10 for rotating the frame body 11 about a vertical axis so that the solar energy plates 12 can be oriented toward the sun.

However, the overall weight of the frame body 11 plus the solar energy plates 12 is very heavy, thereby resulting in a heavy load upon the motor and a high power consumption during angular adjustment of the frame body 11.

### SUMMARY OF THE INVENTION

Therefore, the object of the present invention is to provide an angle-adjustable solar energy device that consumes a relatively low amount of power as compared to the aforesaid conventional solar energy device.

Accordingly, an angle-adjustable solar energy device of the present invention comprises: a fixed supporting frame having at least one cell that defines a cell space; a coupling frame received in the cell space, defining a frame space, and pivoted to the cell of the fixed supporting frame so as to be rotatable relative to the fixed supporting frame about a first axis; a solar cell carrier including a holder that is adapted to hold a solar cell, that extends into the frame space, and that is pivoted to the coupling frame so as to be rotatable relative to the coupling frame about a second axis which intersects the first axis and so as to be rotatable together with the coupling frame relative to the fixed supporting frame about the first axis; a universal joint connected to the holder; and a driving unit connected to the holder through the universal joint so as to drive pivoting movement of the holder relative to the fixed supporting frame.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary assembled perspective view of a conventional angle-adjustable solar energy device;

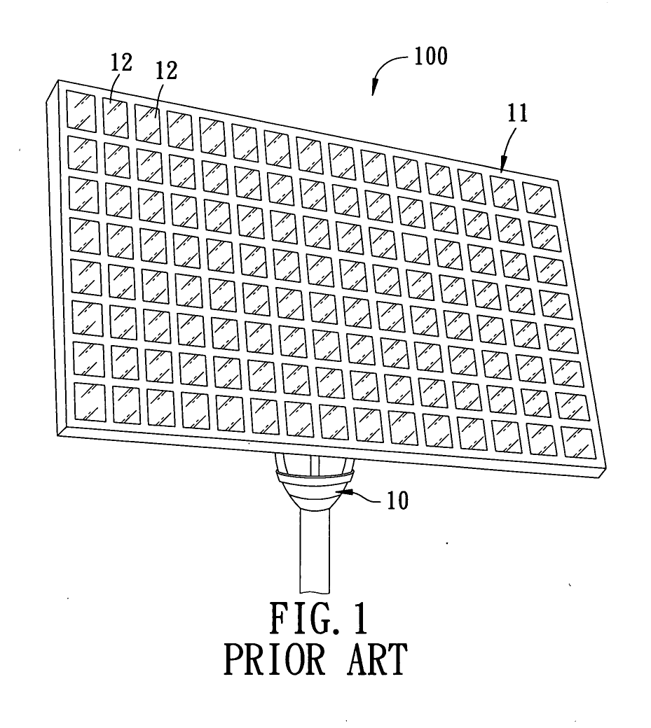

FIG. 2 is a fragmentary assembled perspective view of the preferred embodiment of an angle-adjustable solar energy device according to the present invention;

FIG. 3 is a fragmentary top view of a cell of a fixed supporting frame of the preferred embodiment;

FIG. 4 is a sectional view taken along line IV-IV of FIG. 3; and

FIG. 5 is a sectional view to illustrate how a holder of a solar cell carrier of the preferred embodiment is driven to pivot about an axis.

### DETAILED DESCRIPTION OF THE PREFERRED EMBODIMENT

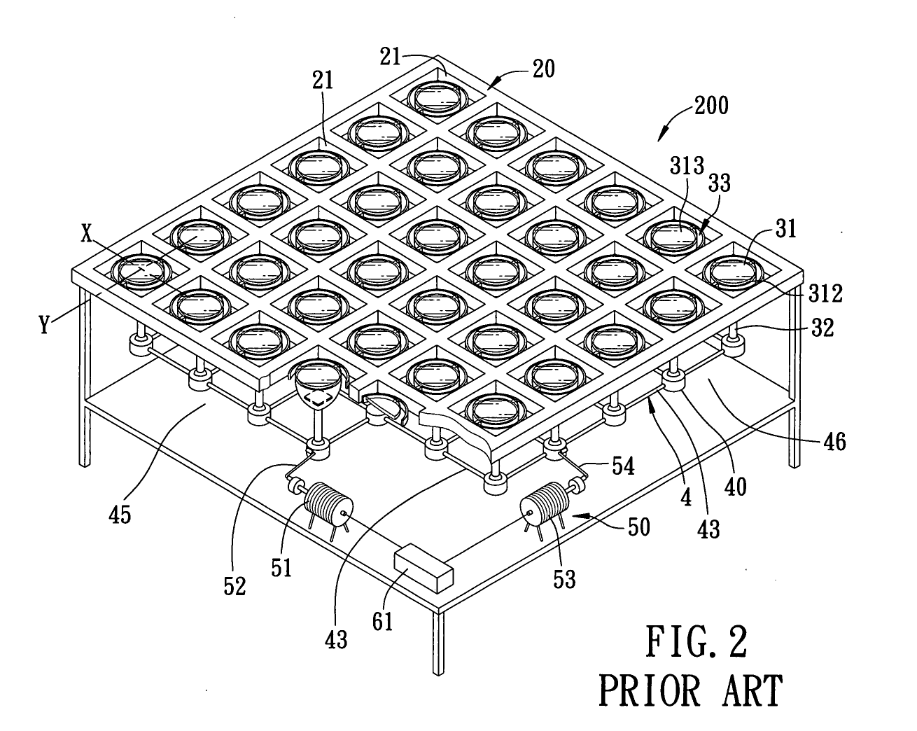

FIGS. 2, 3 and 4 illustrate the preferred embodiment of an angle-adjustable solar energy device 200 according to the present invention.

The solar energy device 200 includes: a fixed supporting frame 20 having an array of cells 21, each of which defines a cell space 210; a plurality of coupling frames 33, each of which is received in the cell space 210 in a respective one of the cells 21, defines a frame space 330, and is pivoted to the respective one of the cells 21 of the fixed supporting frame 20 so as to be rotatable relative to the fixed supporting frame 20 about a first axis (X); a plurality of solar cell carriers 31, each of which includes a holder 312 that defines a holding space 313 for accommodating and holding a solar cell 62 therein, that extends into the frame space 330 in a respective one of the coupling frames 33, and that is pivoted to the respective one of the coupling frames 33 so as to be rotatable relative to the respective one of the coupling frames 33 about a second axis (Y) which intersects the first axis (X) and so as to be rotatable together with the respective one of the coupling frames 33 relative to the fixed supporting frame 20 about the first axis (X); a universal joint unit 4 including an array of interconnected universal joints 40, each of which is disposed below and is connected to the holder 312 of a respective one of the solar cell carriers 31; and a driving unit 50 connected to the holder 312 of each of the solar cell carriers 31 through a respective one of the universal joints 40 of the universal joint unit 4 so as to drive pivoting movement of the holder 312 of each of the solar cell carriers 31 relative to the fixed supporting frame 20.

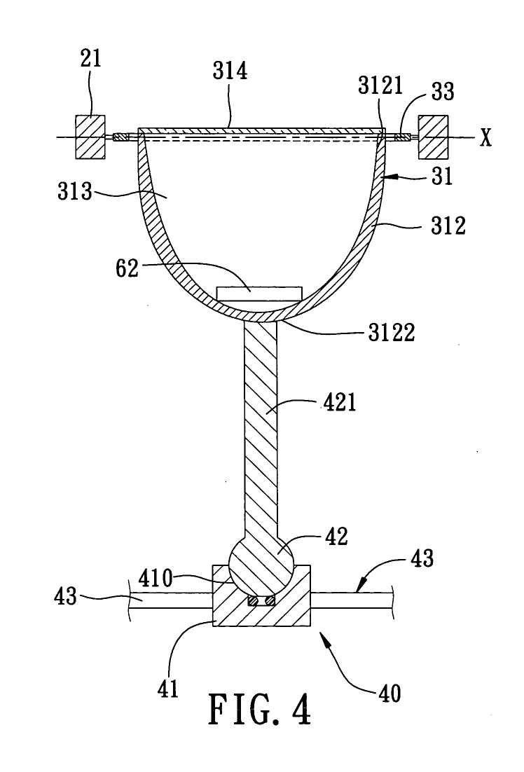

In this embodiment, referring to FIG. 4, the holder 312 of each of the solar cell carriers 31 is bowl-shaped, and has a top open end 3121 pivoted to the respective one of the coupling frames 33, and a bottom end 3122. Each of the universal joints 40 includes a joint block 41 that defines a generally semi-spherical recess 410, a ball 42 received rotatably in the semi-spherical recess 410, and a connecting post 421 that interconnects the ball 42 and the bottom end 3122 of the holder 312 of the respective one of the solar cell carriers 31.

Referring to FIGS. 2 and 4, the array of the universal joints 40 of the universal joint unit 4 has two parallel first sides 45, and two parallel second sides 46 that are transverse to the first sides 45. The universal joint unit 4 further includes a plurality of connecting rods 43, each of which interconnects the joint blocks 41 of two adjacent ones of the universal joints 40.

The driving unit 50 includes a first motor 51 disposed at one of the first sides 45 of the array of the universal joints 40, a first pulling string 52 connected to the first motor 51 and a selected one of the universal joints 40 that is disposed at said one of the first sides 45 of the universal joints 40, a second motor 53 disposed at one of the second sides 46 of the array of the universal joints 40, and a second pulling string 54 connected to the second motor 53 and a selected one of the universal joints 40 that is disposed at said one of the second sides 46 of the array of the universal joints 40.

In this embodiment, the first and second axes (X, Y) lie on a horizontal plane and are perpendicular to each other. The first and second pulling strings 52, 54 are parallel to the horizontal plane. The first pulling string 52 is perpendicular to the first axis (X), whereas the second pulling string 54 is perpendicular to the second axis (Y).

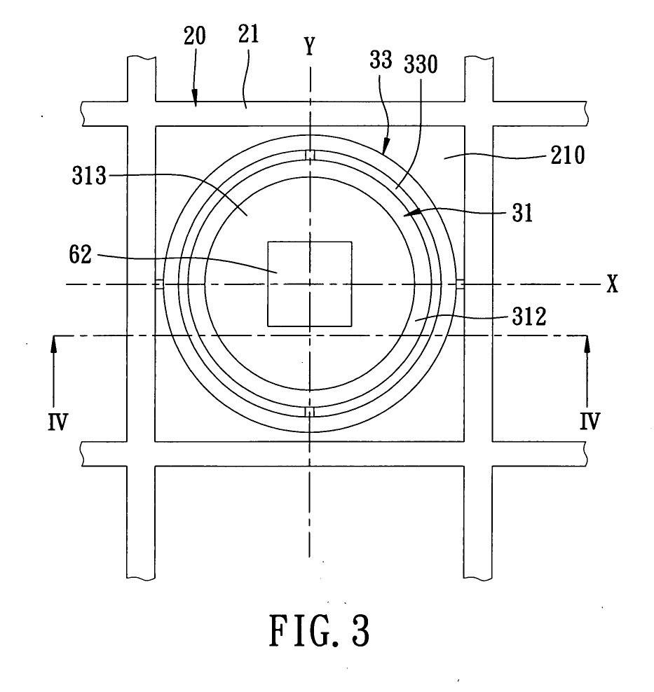

Referring to FIGS. 3 and 4, each of the cells 21 of the fixed supporting frame 20 is square in shape, and each of the coupling frames 33 is ring-shaped. The angle-adjustable solar energy device 200 further includes a plurality of light-collecting lenses 314, each of which is mounted on the top open end 3121 of the holder 312 of a respective one of the solar cell carriers 31.

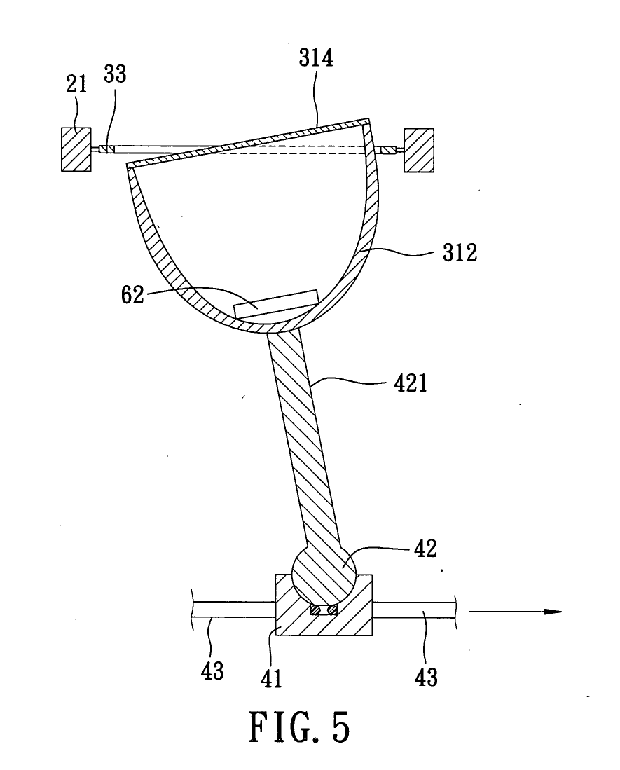

Referring to FIG. 2, the solar energy device 200 further includes a control module 61 connected electrically to the solar cells 62 and the driving unit 50. The control module 61 can detect an electrical output of each of the solar cells 62 such that as the electrical output of each solar cell 62 declines, the control module 61 will drive the first and second motors 52, 54 to move the universal joints 40 so as to adjust the inclination of the solar cells 62 (see FIG. 5) relative to the horizontal plane for optimal reception of sunlight for subsequent photo-electric conversion.

Since the overall weight of the solar cells 62, the solar cell carriers 31, and the universal joint unit 4 is applied to the fixed supporting frame 20, since each of the solar cell carriers 31 is pivoted to the fixed supported frame 20, and since the universal joint unit 4 of the solar energy device 200 of this invention is moved in a direction parallel to the horizontal plane (unlike the aforesaid conventional solar energy device in which the motor is required to adjust the angle of the frame body 11), pivoting movement of the holders 312 of the solar cell carriers 31 can be easily driven by the first and second motors 52, 54. Hence, the load of the first and second motors 52, 54 is considerably reduced as compared to that of the aforesaid conventional solar energy device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An angle-adjustable solar energy device comprising:
a fixed supporting frame having at least one cell that defines a cell space;
a coupling frame received in said cell space, defining a frame space, and pivoted to said cell of said fixed supporting frame so as to be rotatable relative to said fixed supporting frame about a first axis;
a solar cell carrier including a holder that is adapted to hold a solar cell, that extends into said frame space, and that is pivoted to said coupling frame so as to be rotatable relative to said coupling frame about a second axis which intersects said first axis and so as to be rotatable together with said coupling frame relative to said fixed supporting frame about said first axis;
a universal joint connected to said holder; and
a driving unit connected to said holder through said universal joint so as to drive pivoting movement of said holder relative to said fixed supporting frame.

2. The angle-adjustable solar energy device as claimed in claim 1, wherein said holder is bowl-shaped, and has a circular top open end spaced apart from and pivoted to said coupling frame, and a bottom end, said universal joint including a joint block that is disposed below said holder and that defines a generally semi-spherical recess, a ball received rotatably in said semi-spherical recess, and a connecting post that interconnects said ball and said bottom end of said holder.

3. The angle-adjustable solar energy device as claimed in claim 2, wherein said driving unit includes a motor and a pulling string connected to said joint block, said first and second axes lying on a horizontal plane and being perpendicular to each other, said pulling string being parallel to said horizontal plane.

4. The angle-adjustable solar energy device as claimed in claim 2, wherein said coupling frame is ring-shaped.

5. The angle-adjustable solar energy device as claimed in claim 2, further comprising a light-collecting lens mounted on said top open end of said holder.

6. An angle-adjustable solar energy device comprising:
a fixed supporting frame having an array of cells, each of which defines a cell space;
a plurality of coupling frames, each of which is received in said cell space in a respective one of said cells, defines a frame space, and is pivoted to the respective one of said cells of said fixed supporting frame so as to be rotatable relative to said fixed supporting frame about a first axis;
a plurality of solar cell carriers, each of which includes a holder that is adapted to hold a solar cell, that extends into said frame space in a respective one of said coupling frames, and that is pivoted to the respective one of said coupling frames so as to be rotatable relative to the respective one of said coupling frames about a second axis which intersects said first axis and so as to be rotatable together with the respective one of said coupling frames relative to said fixed supporting frame about said first axis;
a universal joint unit including an array of interconnected universal joints, each of which is disposed below and is connected to said holder of a respective one of said solar cell carriers; and
a driving unit connected to said holder of each of said solar cell carriers through said universal joint unit so as to drive pivoting movement of said holder of each of said solar cell carriers relative to said fixed supporting frame.

7. The angle-adjustable solar energy device as claimed in claim 6, wherein said holder of each of said solar cell carriers is bowl-shaped, and has a top open end pivoted to the respective one of said coupling frames, and a bottom end, each of said universal joints including a joint block that defines a generally semi-spherical recess, a ball received rotatably in said semi-spherical recess, and a connecting post that interconnects said ball and said bottom end of said holder of the respective one of said solar cell carriers.

8. The angle-adjustable solar energy device as claimed in claim 7, wherein said array of said universal joints has two parallel first sides, and two parallel second sides that are transverse to said first sides, said universal joint unit further including a plurality of connecting rods, each of which interconnects said joint blocks of two adjacent ones of said universal joints, said driving unit including a first motor disposed at one of said first sides of said array of said universal joints, a first pulling string connected to said first motor and a selected one of said universal joints that is disposed at said one of said first sides of said array of said universal joints, a second motor disposed at one of said second sides of said array of said universal joints, and a second pulling string connected to said second motor and another selected one of said universal joints that is disposed at said one of said second sides of said array of said universal joints.

9. The angle-adjustable solar energy device as claimed in claim 8, wherein said first and second axes lie on a horizontal plane and are perpendicular to each other, said first and second pulling strings being parallel to said horizontal plane, said first pulling string being perpendicular to said first axis, said second pulling string being perpendicular to said second axis.

10. The angle-adjustable solar energy device as claimed in claim 6, wherein each of said cells of said fixed supporting frame is square in shape, each of said coupling frames being ring-shaped.

11. The angle-adjustable solar energy device as claimed in claim 6, further comprising a plurality of light-collecting lenses, each of which is mounted on said top open end of said holder of a respective one of said solar cell carriers.
